(19) United States
(12) Patent Application Publication
(10) Pub. No.: US 2005/0113133 A1
(43) Pub. Date: May 26, 2005

(54) Dynamically tuned antenna used for multiple purposes

(76) Inventor: Kevin Li, San Diego, CA (US)

Correspondence Address: Milan Patel;c/o Nokia Mobile Phones (Patent Dept.), Mail Stop 1-4-755, 6000 Connection Drive, Irving, TX, 75039, US

(21) Appl. No.: 10/723,138

(22) Filed: Nov. 25, 2003

(51) Int. Cl. H04M 1/00

(52) U.S. Cl. 455/552.1; 455/575.7; 455/456.6

(57) ABSTRACT

A system that effectuates receive diversity within a mobile communication device is provided. A first antenna facilitates reception of signals in a PCS band, and a second antenna facilitates reception of signals in a GPS band and a PCS band. Tuning of the second antenna depends upon a signal type relayed to the second antenna.

### TECHNICAL FIELD

The present invention generally relates to mobile communications devices. More particularly, the present invention relates to utilizing a single antenna structure with respect to enabling receive diversity and GPS communications within a mobile communications device.

### BACKGROUND OF THE INVENTION

Early mobile communication devices employed analog radio transmission such as Advanced Mobile Phone System (AMPS), for example. Such analog technologies were sufficient for an emerging mobile communications consumer market. However, within a relatively short period of time, millions of new mobile communications subscribers, demanding more and more airtime, pushed the existing analog technology to a capacity limit or ceiling. As a consequence, dropped calls and busy signals became common, which fueled a demand for an improved mobile communication network.

In response to the demand, industry developed digital wireless technologies that could accommodate the increased network traffic within a limited amount of radio spectrum. For example, technologies such as Global System for Mobile (GSM) employing Time Division Multiple Access (TDMA) were developed, wherein a time-sharing protocol was employed to provide three to four times more capacity than the existing analog technologies. In general, TDMA employs a technique wherein a communication channel is divided into sequential time slices. Each user of a channel is provided with a time slice for transmitting and receiving information in a round-robin manner. For example, at any given time “t,” a user is provided access to the channel for a short burst. Then, access switches to another user who is provided with a short burst of time for transmitting and receiving information. The cycle of “taking turns” continues, and eventually each user is provided with multiple transmission and reception bursts.

Shortly after TDMA was introduced, Code Division Multiple Access (CDMA) was developed, and represented an enhanced solution to the analog transmission deficiencies. Code Division Multiple Access provides for “true” sharing, wherein one or more users can transmit and receive concurrently. Code Division Multiple Access provides sharing via employing spread spectrum digital modulation, wherein a user's stream of bits is encoded and spread across a very wide channel in a pseudo-random fashion. The receiver is designed to recognize and undo the randomization in order to collect the bits for a particular user in a coherent manner. Code Division Multiple Access provides approximately ten times the capacity of the analog technologies, and enables increased voice quality, broader coverage and increased security. Today, CDMA is one of the prevalent technologies employed in mobile systems.

Technological advances in the electronics and computer industries, including smaller components, reduced power consumption, and the Internet, for example, have driven the mobile communications industry to further GSM and CDMA technologies, and to explore other technologies. One such improvement includes EDGE (Enhanced Data-Rates for Global Evolution) technology. The evolution of GSM to EDGE mitigates various issues associated with voice traffic bandwidth and provides higher data throughput, affording for more efficiency and higher performance. For example, EDGE provides for data rates up to 384 Kbps (with a bit-rate up to 69.2 Kbps per timeslot) over broadband. In addition, EDGE provides for more robust services such a Short Message Service (SMS) and Multimedia Message Service (MMS) for messaging, XHTML (including WAP) browsing, Java applications, FM radio reception, video streaming, and voice and image recording technologies.

Another result of continued efforts to improve mobile communications includes the International Telecommunications Union's adoption of an industry standard for third-generation (3G) wireless systems that can provide high-speed data rates (e.g., for data transmission and Internet use) and new features. Currently, three operating modes (CDMA2000, WCDMA and TD-SCDMA) based on CDMA technology are being developed. CDMA2000 technology provides a relatively simple, quick, and cost-effective path to 3G service. CDMA2000 1× technology supports voice and data services over a standard IS-95 CDMA channel. Additionally, it provides up to twice the capacity (e.g., peak data rates up to 153 kbps and projected peak data rates up to 307 kbps, without compromising voice capacity) of the earlier CDMA networks. The additional capacity accommodates the continuing growth in the wireless Internet market. Moreover, CDMA2000 1× provides longer standby times and is backwards compatible. CDMA2000 1×EV-DO technology provides a data optimized version of CDMA2000 with peak data rates over 2 Mbps and an average throughput of over 700 kbps, which is comparable to DSL and can support video streaming and large file downloads. CDMA2000 1×EV-DV technology is an enhanced version of CDMA 1× that facilitates improved performance in connection with data and voice transmissions within a wireless network. WCDMA and TD-SCDMA represent more complex enhancements that can entail more costly and complex components, new network designs, and longer verification and validation periods.

Current technologies within the global mobile communication community include cellular, Personal Communication Service (PCS) and Global Positioning System (GPS), for example. Cellular communication is typically associated with frequencies around 850 MHz. Personal Communication Service is typically associated with frequencies around 1900 MHz. Global Positioning System is typically associated with frequencies around 1600 MHz.

Referring more particularly to CDMA2000 1×EV-DO and CDMA2000 1×EV-DV, these communication protocols can operate more robustly if receive and/or transmit diversity in a PCS frequency band is added to a mobile communication device. For instance, high-speed applications are effectuated with less difficulty if receive diversity and/or transmit diversity is enabled within mobile communication devices (e.g., higher data rates can be obtained). Moreover, a substantially greater number of mobile communication devices that can concurrently be operable in particular locations of a network can be effectuated via receive and/or transmit diversity. Additionally, a links between mobile communication devices and base stations are improved when receive diversity and/or transmit diversity is enabled.

Receive and/or transmit diversity in the PCS band, however, requires use of an additional antenna (e.g., receive diversity utilizes two disparate antennas to enable stronger links and faster data transmission rates). Thus, conventional systems require an additional antenna tuned to the PCS band to be added to the phone. As antennas require a substantial amount of space within mobile communication devices, however, re-design of existing mobile communication devices may be required to provide necessary space for the additional antenna. Such design can be costly and time-consuming, and the resulting design can require a mobile communication device to be larger and heavier than desirable by typical users.

In view of at least the above, there exists a strong need in the art for a system and/or methodology that enables mobile communication devices to include receive diversity without requiring the complete redesign of existing devices.

### SUMMARY OF THE INVENTION

The following presents a simplified summary of the invention in order to provide a basic understanding of some aspects of the invention. This summary is not an extensive overview of the invention. It is not intended to identify key or critical elements of the invention or delineate the scope of the invention. Its sole purpose is to present some concepts of the invention in a simplified form as a prelude to the more detailed description that is presented later.

The present invention enables utilization of pre-existing designs within mobile communication devices (e.g., portable telephones) to provide receive diversity within such devices. Thus, substantial cost of complete re-design of mobile communication devices can be avoided while the communication devices are optimized for use with third generation wireless network protocols. Moreover, size, weight, and cost of mobile communication devices is not significantly affected when implemented with one or more aspects of the present invention. The present invention is a product of the inventor's realization that a substantial amount of designs of mobile communication devices comprise antennas that facilitate reception of GPS signals. Thus, through addition of tuning and reception circuitry, the antenna can be employed to receive GPS signals and PCS signals without requiring an additional antenna that is dedicated for receive diversity.

Thus, the present invention contemplates a mobile communication device with two or more antennas, wherein a first antenna is configured to receive signals in particular bands, and a second antenna is configured to receive either signals within such bands or signals within a GPS band at a particular point in time. For example, in accordance with one aspect of the present invention, the first antenna can be configured to receive PCS signals, and the second antenna can be dynamically to receive either PCS signals or GPS signals. Such an aspect enables receive diversity within a mobile communication device without requiring an additional antenna dedicated to receiving PCS signals. It is to be understood, however, that the present invention contemplates any system and/or methodology that employs a first antenna to receive signals in one or more bands and a second antenna that can be dynamically tuned to receive signals in at least one of the same bands that the first antenna can receive and a GPS band.

Configuration of the second antenna (e.g., between PCS signals and GPS signals) can depend on type of signal desirably received by the second antenna. For example, if no GPS signal is being relayed to the second antenna, a tuning component that facilitates tuning the second antenna for PCS signal reception can be employed to effectuate such tuning. At a later point in time, if a GPS signal is being relayed to the second antenna, a tuning component that facilitates tuning the second antenna for GPS signal reception can be utilized in connection appropriately tuning the second antenna. In accordance with one aspect of the present invention, the second antenna will automatically configure itself to receive a GPS signal if a GPS signal is desirably received by the second antenna. Thus, for example, if the second antenna is being used to receive a PCS signal and then a GPS signal is desirably received, the antenna will configure itself to receive the GPS signal. Such an aspect can be beneficial to a user, as temporarily disabling receive diversity will not typically be noticeable by such user. However, a GPS signal can be imperative to the safety of the user at a particular point in time (e.g., during a medical emergency). However, it is to be understood that other similar embodiments are contemplated by the present invention and intended to fall within the scope of the hereto-appended claims.

In accordance with another aspect of the present invention, a switch can be provided to selectably couple the second antenna to an appropriate tuning component. For instance, if the second antenna is configured to receive PCS signals and a GPS signal is desirably received by the second antenna, the switch can couple the second antenna to a tuning component that facilitates tuning the antenna to enable reception of GPS signals. Alternatively, in an instance that the second antenna is configured to receive GPS signals and a PCS signal is desirably receive by such antenna, the switch can couple the antenna to a tuning component that facilitates configuring the antenna for PCS signal reception. Similarly, components that effectuate processing, transduction, and/or manipulation of particular signals received by the antenna can be coupled to the antenna via a switch. For instance, a component designed to process and/or manipulate a GPS signal (e.g., a GPS receiver) can be automatically coupled to the second antenna via a switch upon a determination that receipt of a GPS signal is desirable. Additionally, a component designed to process and/or manipulate a PCS signal can automatically be coupled to the antenna via a switch upon a determination that receipt of a PCS signal is desirable.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 is a block diagram of a system that facilitates utilizing a single antenna for GPS reception and receive diversity in a PCS band in accordance with an aspect of the present invention.

FIG. 2 is a block diagram of a system that facilitates utilizing a single antenna for GPS reception and receive diversity in a PCS band in accordance with an aspect of the present invention.

FIG. 3 is a representative flow diagram that illustrates a methodology that facilitates reception of GPS signals and reception of PCS signals in accordance with one aspect of the present invention.

FIG. 4 is an exemplary antenna system that can be utilized in connection with one aspect of the present invention.

FIG. 5 is an exemplary antenna system that can be utilized in connection with one aspect of the present invention.

FIG. 6 is an exemplary antenna system that can be utilized in connection with one aspect of the present invention.

FIG. 7 is an exemplary antenna system that can be utilized in connection with one aspect of the present invention.

FIG. 8 is an exemplary antenna system that can be utilized in connection with one aspect of the present invention.

FIG. 9 illustrates a portion of a PWB in accordance with an aspect of the present invention.

FIG. 10 illustrates an exemplary antenna system mounted onto the PWB in accordance with an aspect of the present invention.

FIG. 11 is a representative flow diagram that illustrates a methodology that facilitates modification of a mobile communication device to allow receive diversity in accordance with one aspect of the present invention.

FIG. 12 is an exemplary operating environment in accordance with an aspect of the present invention.

FIG. 13 illustrates an exemplary mobile device wherein the invention can be employed.

FIG. 14 illustrates an exemplary computing environment wherein the invention can be employed.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

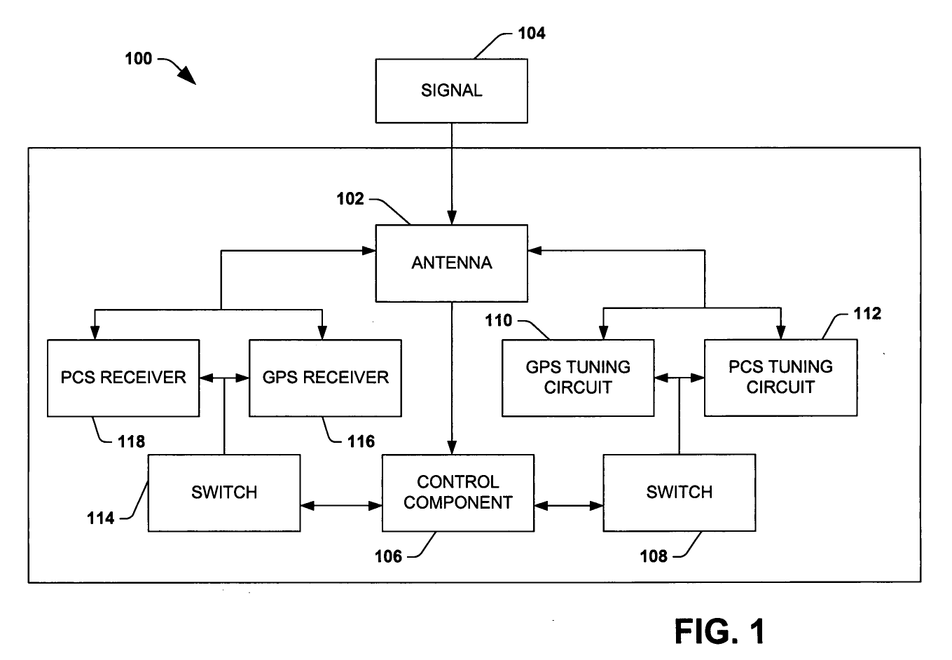

Referring now to FIG. 1, a system 100 that facilitates enabling receive diversity within a mobile device without requiring an additional antenna dedicated to such purpose is illustrated. The system 100 utilizes an antenna that can be tuned between frequencies that facilitate reception of GPS signals (1.575 GHz) and PCS signals (1.91-1.99 GHz). Note that other systems operating at frequencies near PCS (Korean PCS ˜1700 MHz or China PCS ˜2100 MHZ) can also be utilized instead of or in addition to PCS and are contemplated by the present invention. In accordance with one aspect of the present invention, location and design of the antenna can be previously completed to enable reception of GPS signals via an antenna designed for such purposes. Thus, only slight modification (e.g., inclusion of circuitry enabling reception, tuning circuitry, and simple switches) is necessary to enable receive diversity within a mobile communication device.

The system 100 comprises an antenna 102 that receives a signal 104 carrying GPS and/or PCS data. In accordance with one aspect of the present invention, the antenna 102 can include a TOPIFA (top-mounted inverted F-antenna) transducer that exhibits circular polarization. Moreover, the antenna 102 can be a dual-band antenna to enable switching between frequencies that carry PCS and GPS data. Additionally, the antenna can be a low-profile printed antenna, such as a microstrip patch antenna or a planar inverted-F antenna (PIFA), so that components that effectuate tuning the antenna 102 can be easily integrated with such antenna 102. The aforementioned antennas are simply exemplary, and it is understood that any suitable antenna structure can be employed in connection with the present invention (e.g., monopole whip, dielectric resonator antenna (DRA), normal-mode helix, E-plane antenna . . . ). PCS or GPS signals will be received depending on the use of the mobile communication device. Typically, if GPS data is desired by the user, then GPS signals will be received. If GPS data is not desired by the user and PCS data is desired, then PCS signals will be received. The antenna 104 will be employed for receive diversity, and therefore will not be a sole antenna that receives PCS data. Thus, when GPS data is desired by the user, the antenna 104 will typically be tuned to effectively receive GPS data, and the system 100 will facilitate further processing of such data (e.g., the system 100 can utilize various algorithms to process and/or display and/or transmit GPS related data).

A control component 106 can be employed to determine which type of data (either PCS or GPS data) is to be received from within the signal 104, and thereafter relay commands to a switch 108 in an instance that the antenna 102 requires tuning to facilitate reception of a particular type of data (e.g., PCS or GPS). The switch 108 is coupled to a GPS tuning component 110 and a PCS tuning component 112, wherein the tuning components 110 and 112 facilitate dynamically tuning the antenna 102 to enable optimal reception of the signal 104. For example, if GPS data is desired from the signal 104, the control component 106 can relay commands to the switch 108. The switch 108 can be employed to connect the GPS tuning component 110 to the antenna 102, and the GPS tuning component 110 can tune the antenna 102 so that it resonates at an appropriate frequency (e.g., 1.575 GHz). Thereafter, if PCS data is desired from the signal 104, the control component 106 can relay appropriate commands to the switch 108. The switch 108 can thereafter effectuate connection of the antenna 102 to the PCS tuning component 112, and the antenna 102 can be appropriately tuned via the PCS tuning component 112. The tuning components 110 and 112 can include a reactive element, part of a transmission line, or other suitable components and/or methodologies that can be employed in connection with tuning the antenna 102.

The control component 106 can also relay commands to a second switch 114 to enable data within the signal 104 to be processed by appropriate circuitry. For instance, the control component 106 can determine which type of data is to be received from the signal 104 (e.g., PCS or GPS), and thereafter facilitate coupling the antenna 102 to appropriate circuitry. More particularly, the switch 114 can couple the antenna 102 to a GPS receiver 116 if GPS data is desired from the signal 104, and can couple the antenna 102 to a PCS receiver 118 if PCS data is desired from the signal 104. For example, the GPS receiver 116 and the PCS receiver 118 can include transducers that effectuate transforming magnetic signals into electrical signals. In accordance with one aspect of the present invention, the switches 108 and 114 can be a MEMS (micro electro-mechanical system), FET, PIN-diode, or other suitable technology that can be employed as a switch. Moreover, RF switches can be more easily employed without causing cross-modulation or non-linearity problems, as the system 100 is employed only to receive data. Moreover, the switches 108 and 114 would not require significant RF power handling capacity, thereby further mitigating concerns of cross-modulation and non-linearity.

The system 100 thus enables a mobile communication device to utilize a single antenna for GPS reception capability and receive diversity capability. Real estate within the mobile communication device is saved, as an additional antenna is not added to the phone. Moreover, as frequencies carrying GPS and PCS signals are proximate, tuning circuitry to tune the antenna need not be complex. Furthermore, utilizing a pre-existing antenna will ensure that when the antenna is utilized for GPS that reception with such antenna will compare favorably to an antenna dedicated solely for GPS reception.

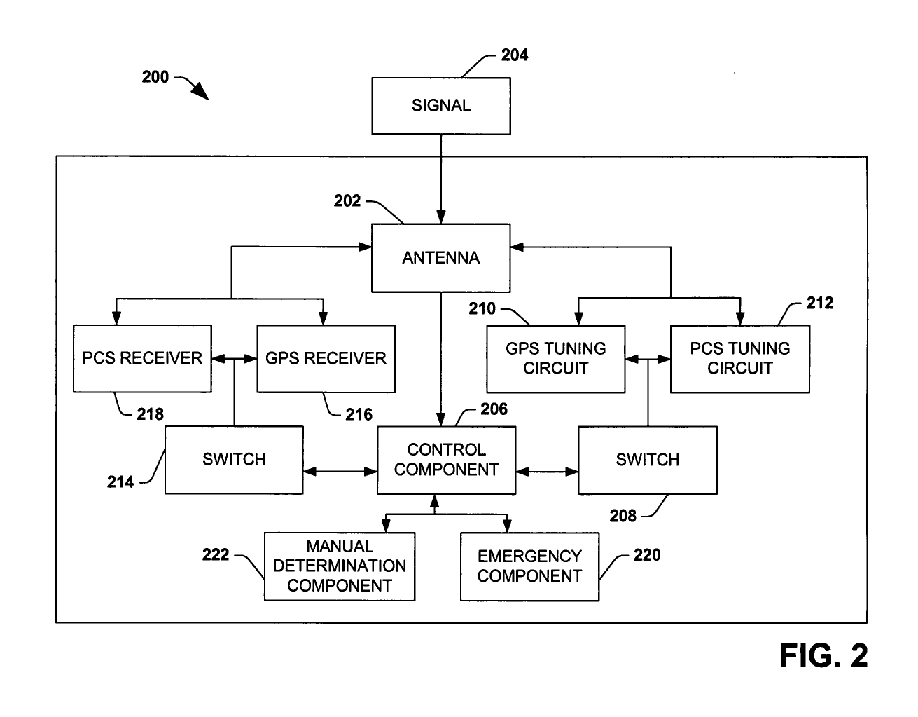

Now referring to FIG. 2, a system 200 that facilitates utilizing a single antenna for GPS and receive diversity purposes is illustrated. The system 200 comprises an antenna 202 that receives a signal 204 containing PCS data and/or GPS data. A control component 206 can determine which type of data is being received, and relay commands to a switch 208 that facilitates tuning the antenna 202 corresponding to the frequency of the signal 204. For instance, if the control component 206 determines that GPS data is being received, then the component can relay commands to the switch 208 to effectuate tuning of the antenna 202 via a GPS tuning component 210. Furthermore, if the control component 206 determines that PCS data is being received from the signal 204, the control component 206 can relay commands to the switch 208 to effectuate tuning of the antenna via a PCS tuning component 212. Thereby the system 200 will be capable of receiving the signal 204 and processing such signal 204.

Moreover, the control component 206 can relay commands to a second switch 214 that facilitates coupling the antenna 202 with a GPS receiver 216 or a PCS receiver 218. For instance, if GPS data is received from the signal 204, the control component 206 will relay commands to the switch 214 to effectuate coupling the antenna 202 with the GPS receiver. The control component 206 can also be associated with an emergency component 220 that automatically informs the control component 206 to prepare the system 200 to receive GPS data. For example, if a user dials an emergency number, it may be imperative that a responsive emergency unit knows a location of the user. More particularly, if dialing “911” will connect a mobile communication device to an emergency line, the emergency component 220 can sense depression of buttons that are utilized to dial such numbers and facilitate automatic preparation of receipt of GPS signals by the antenna 202 (e.g., the antenna 202 can be tuned and the GPS receiver 216 can be coupled to the receiver in anticipation of GPS signals).

In accordance with another aspect of the present invention, the control component 206 can be associated with a manual override component 222 that enables a user to select a manner in which to utilize the antenna 202. For example, if a user would prefer to utilize the antenna 202 for receive diversity purposes regardless of existence of GPS data within the signal 204, the manual override component 222 can effectuate such user-preference. For instance, the manual override component 222 can be employed upon a keystroke or a combination of keystrokes, voice command, or other suitable command.

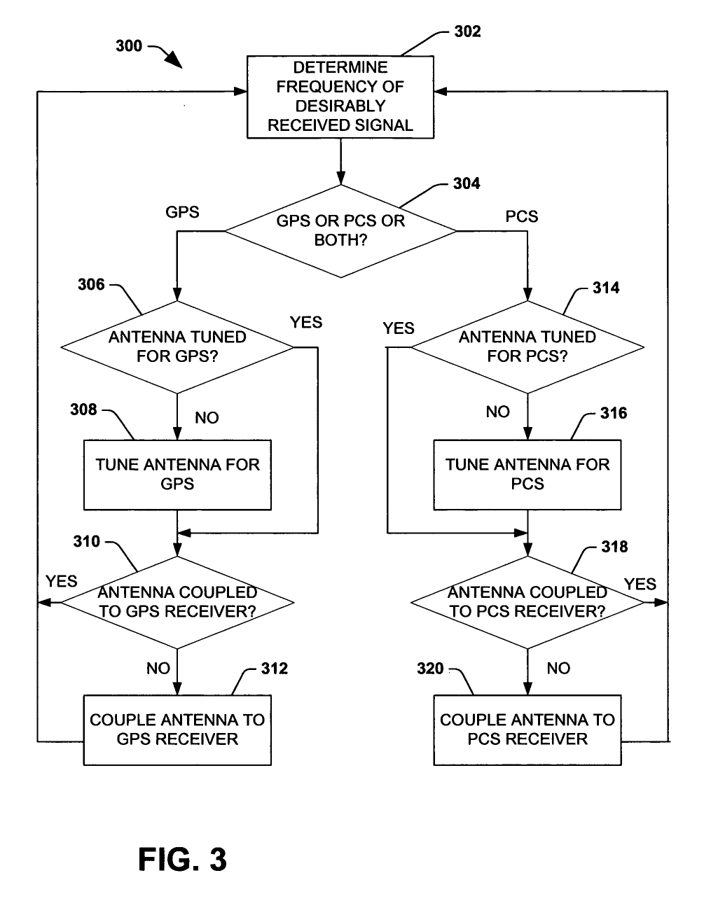

Turning now to FIG. 3, a methodology 300 that facilitates utilizing a single antenna for GPS data reception and receive diversity is illustrated. While, for purposes of simplicity of explanation, the methodology 300 is shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

At 302, a frequency of a desired signal received by an antenna is determined. At 304, a determination is made regarding whether receiving a GPS signal or a PCS signal is desired. If a GPS signal is desired to be received then a determination is made at 306 regarding whether the antenna has been tuned appropriately to effectuate optimal reception and/or processing of the GPS signal. The methodology 300, in general places a preference upon GPS signals because a user typically will not notice that receive diversity has been disabled. More particularly, receive diversity enables more mobile communication devices to be connected within a same cell region and can provide for faster data rates. However, an individual user will not typically be affected by such benefits (but collectively a group of users is positively affected by enabling receive diversity). If the antenna has not been tuned, then at 308 such antenna is tuned by a suitable tuning component to optimally receive GPS signals. At 310 a determination is made regarding whether the antenna is coupled to a receiver capable of receiving and/or processing GPS signals. If no, then at 312 the antenna is coupled to a GPS receiver to enable reception and/or processing of the GPS signal. If, at 310, the GPS receiving component is already coupled to the antenna, then the methodology returns to 302.

Returning to 304, if a PCS signal is desired to be received, a determination is made at 314 regarding whether the antenna has been tuned appropriately to effectuate optimal reception and/or processing of the PCS signal. If the antenna has not been tuned, then at 316 such antenna is tuned by a suitable tuning component to optimally receive PCS signals. At 318 a determination is made regarding whether the antenna is coupled to a receiver capable of receiving and/or processing PCS signals. If no, then at 320 the antenna is coupled to a PCS receiver to enable reception and/or processing of the PCS signal. If, at 318, the PCS receiving component is already coupled to the antenna, then the methodology returns to 302.

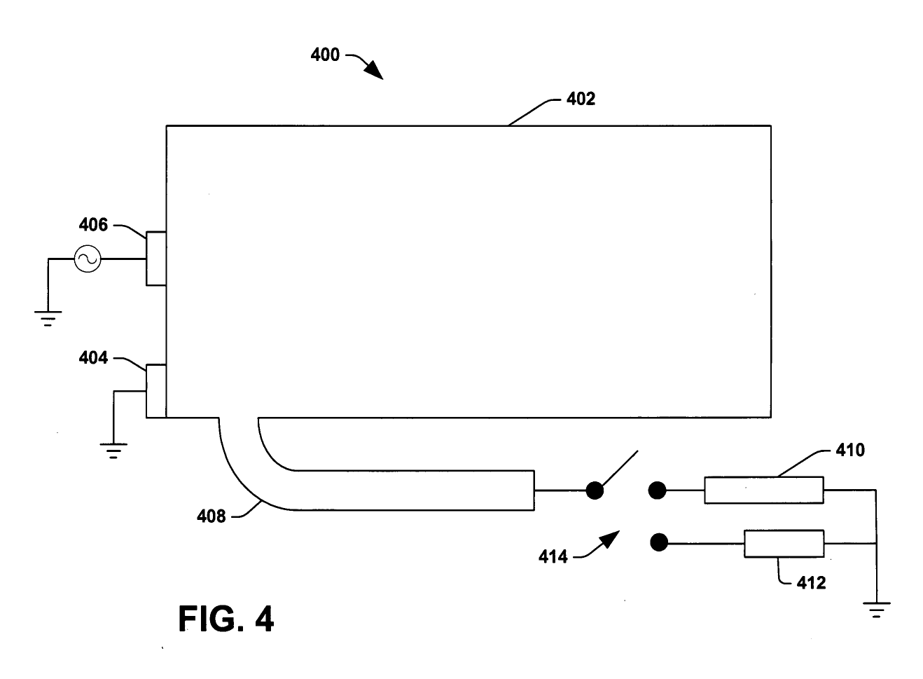

Turning now to FIG. 4, an exemplary schematic of a system 400 that can be employed in connection with the present invention is illustrated. The system 400 includes a radiating antenna element 402 that is shorted by a grounding pin 404 and a feeding line 406. A transmission line 408 can be employed in connection with tuning the radiating antenna element between two disparate frequencies (e.g., a frequency for receiving GPS data and a frequency for receiving PCS data). The radiating antenna element can be tuned between frequencies via altering distance of the transmission line 408. For example, extensions 410 and 412 can be selectively connected to the transmission line 408 via a switch 414, thereby effectuating alteration in distance of such transmission line 408. Thus, when the switch 414 is utilized to connect the transmission line 408 to the first extension 410, the radiating antenna element 402 will be tuned with respect to a first frequency. When the switch 414 is employed to connect the transmission line 408 to the second extension 412, the radiating antenna element 402 will be tuned with respect to a second frequency. Moreover, if transmit diversity is desirably employed in a same antenna that receive diversity and GPS are utilized, then the switch 414 can be left open to generate a third length of the transmission line 408 (and thus a third resonant frequency of the radiating antenna element 402). In accordance with one aspect of the present invention, the radiating antenna element 402 has been designed as a portion of a GPS reception system, and the transmission line 408, first and second extensions 410 and 412, and the switch 414 are subsequently implemented within the design to enable a single antenna to be employed as a GPS receiving antenna and a receive diversity antenna. Such a system 400 and other similar systems that can be employed in connection with the present invention are described in U.S. Pat. No. 6,650,295, entitled “Tunable Antenna for Wireless Communication Terminals”, which is incorporated herein by reference.

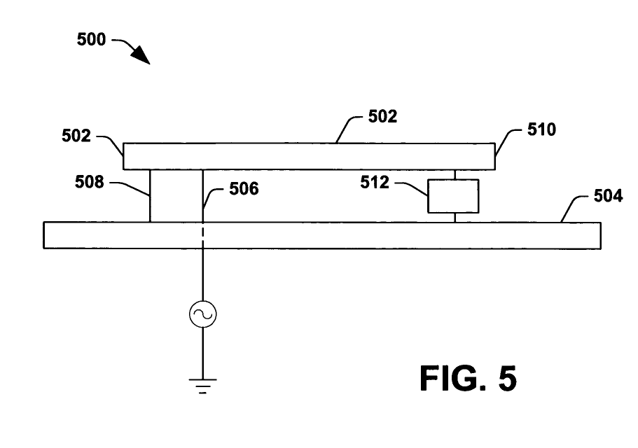

Referring now to FIG. 5, another exemplary system 500 that can be employed in connection with the present invention is illustrated. The system 500 includes a radiating antenna element 502 that is positioned parallel to an electrical reference plane 504, which is typically a ground plane. A first connection mechanism 506 can be employed to couple the radiating antenna element 502 to the reference plane 504, and a planar coupling strip 508 can be employed to couple the radiating antenna element 502 to a transmission line (not shown). The connection mechanism 506 and the planar coupling strip 508 are positioned parallel to one another to create a transmission line. More particularly, a point of contact between the planar coupling strip 508 and the radiating antenna element 502 defines a first electrical point, and acts as a first current source. The first electrical point defines an electrical edge on the radiating antenna element 502 from which an electrical length of the radiating antenna element 502 is defined. The electrical length of the radiating antenna element 502 determines a resonant frequency of the radiating antenna element 502. Thus, for example, in an instance that the radiating antenna element 502 is solely connected to the reference plane 504 via the planar coupling strip 508, the electrical length of the radiating antenna element 502 will extend from an edge 510 to the connecting point of the planar coupling strip 508 with the radiating antenna element 502.

The radiating antenna element 502 is further connected to the reference plane 504 via a filter 512. Characteristics of the filter 512 can be chosen to enable such filter 512 to act as a high impedance path when the radiating antenna element 502 is at resonance (as determined by the electrical length of the radiating antenna element 502). The filter 512 will also have low impedance at a second chosen frequency (e.g. the first frequency can facilitate reception of GPS data and the second frequency can facilitate reception of PCS data). The coupling of the radiating antenna element 502 and the reference plane 504 via the filter creates a second coupling point that acts as a current source, and can thus alter the electrical length of the radiating antenna element 502. The electrical length of the radiating antenna element 502 is determined, at least in part, upon a distance between the planar coupling strip 508 and the filter 512. In accordance with one aspect of the present invention, the radiating antenna element 502 is previously implemented in connection with GPS signals, and the filter and planar coupling strip 508 are subsequently added to enable receive diversity within the system 500. The exemplary system 500 and other similar antenna structures are described in more detail in U.S. Pat. No. 6,515,625, entitled “Antenna”, which is hereby incorporated in its entirety by reference.

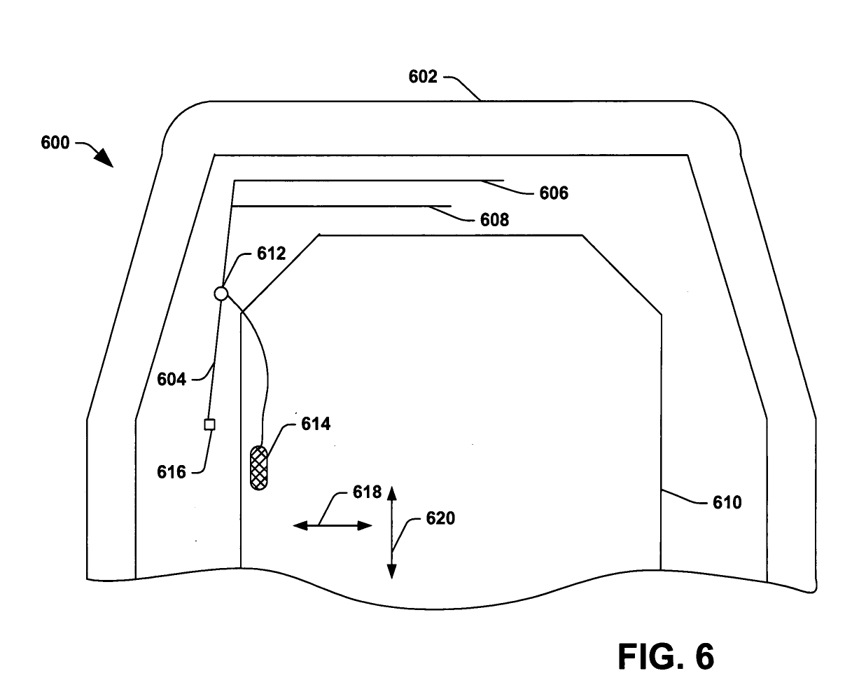

Referring now to FIG. 6, an exemplary portion of a mobile communication device 600 is illustrated. The mobile communication device 600 includes a housing 602 that houses various components that can be employed in connection with the present invention. Typical housings consist of a molded thermoplastic material. The housing 602 supports and encloses an antenna element 604 with extensions 606 and 608, wherein the antenna element is also coupled with various circuit components (e.g., tuning components, GPS and PCS receivers, . . . ) via a printed circuit board that forms a substrate 610. An RF port 612 is electrically coupled to a main feed port 614 formed on the substrate 610, and in turn connected to various circuit components. The housing 602 also houses a ground port 616.

The antenna element 604 and the extensions 606 and 608 create a TOPIFA (Top-Mounted Inverted F-Antenna) antenna. The antenna element 604 is electrically coupled to the RF port 612 and the ground port 616. The antenna illustrated in the present figure exhibits circular polarization characteristics, which can improve gain. Furthermore, the antenna element 604 can be placed proximate to a conventional whip antenna element that can also be connected to various components that are utilized in connection with the present invention. Width and length of the substrate 610 can be selected to permit optimal positioning within the housing 602 as well as cause a circular polarization as exhibited by the antenna. More particularly, a widthwise dimension 618 and a lengthwise dimension 620 can be combined to form a geometric mean value, which can be selected to correspond to a resonance length at which the antenna element 604 is operable. For instance, when the mobile station is operable in the range of 1.5 gigahertz (GHz), the resonance length is related to the wavelength associated with a 1.5 GHz signal. By selecting the dimensions of the substrate 610 in this manner, resonant currents are generated in the substrate 610. The resonant currents form first and second resonant currents generated in a capacitive direction and in an inductive direction of resonance. The inductive and capacitive directions of resonances extend in perpendicular directions, thereby to form a circular resonant structure.

In accordance with one aspect of the present invention, the above antenna and antenna element can be a portion of a pre-existing design of a mobile communication device, wherein such antenna is utilized in connection with receiving GPS data. The design of the mobile communication station can thereafter be modified in connection with the present invention to enable the exemplary antenna to be employed in connection with implementing receive diversity upon the antenna. For example, two or more switches and tuning and matching circuitry can be added upon the substrate 610 in connection with the present invention. Thus the exemplary antenna element 604 can be utilized for GPS purposes and for receive diversity. The above exemplary antenna, as well as other physical embodiments of the antenna is more fully disclosed in U.S. Pat. No. 6,414,640, entitled “Antenna Assembly, and Associated Method, Which Exhibits Circular Polarization” which is herein incorporated in its entirety by reference.

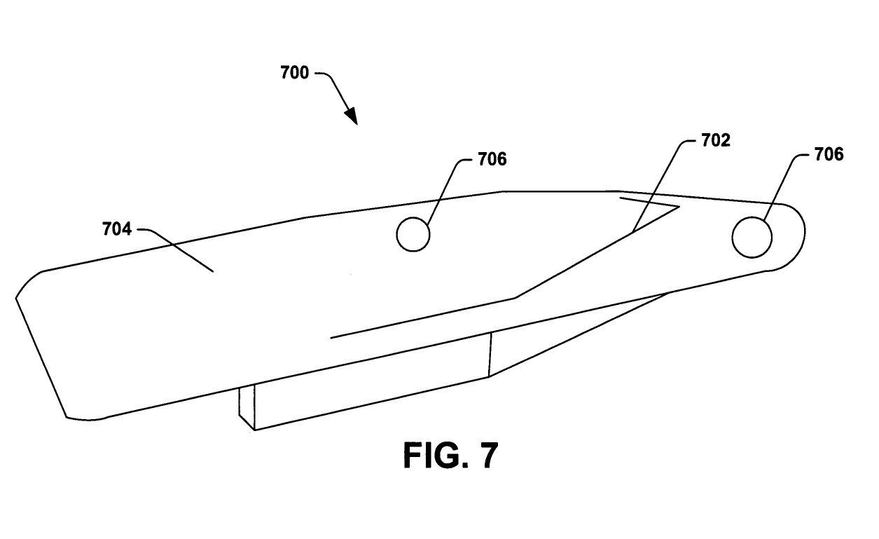

FIGS. 7-11 illustrate an exemplary GPS antenna assembly, a portion of a PWB comprising a GPS antenna assembly mounting mechanism, and a portion of the PWB with the GPS antenna assembly mounted thereon, respectively.

Proceeding to FIG. 7, an exemplary GPS antenna assembly 700 is illustrated. The GPS antenna assembly 700 comprises at least a radiator 702, a carrier 704 and mounting locations 706. Typically, the radiator 702 is constructed of metal such as sheet metal, for example. The radiator 702 can be embedded within the carrier 704 such that it can be exposed from a plurality of sides of the carrier 704, including the side mounted away from a PWB. The radiator 702 can be employed to receive signals within the GPS frequency band. The carrier 704 (e.g., plastic and the like) generally facilitates mounting the GPS antenna assembly 700 to a PWB. The mounting locations 706 provide a means to fasten the GPS antenna assembly 700 to a PWB. For example, mounting components such as stand offs, screws, snaps, clips, solder joints, connectors, wires and the like can be employed in connection with the mounting locations to selectively secure the GPS antenna assembly 700 to a PWB.

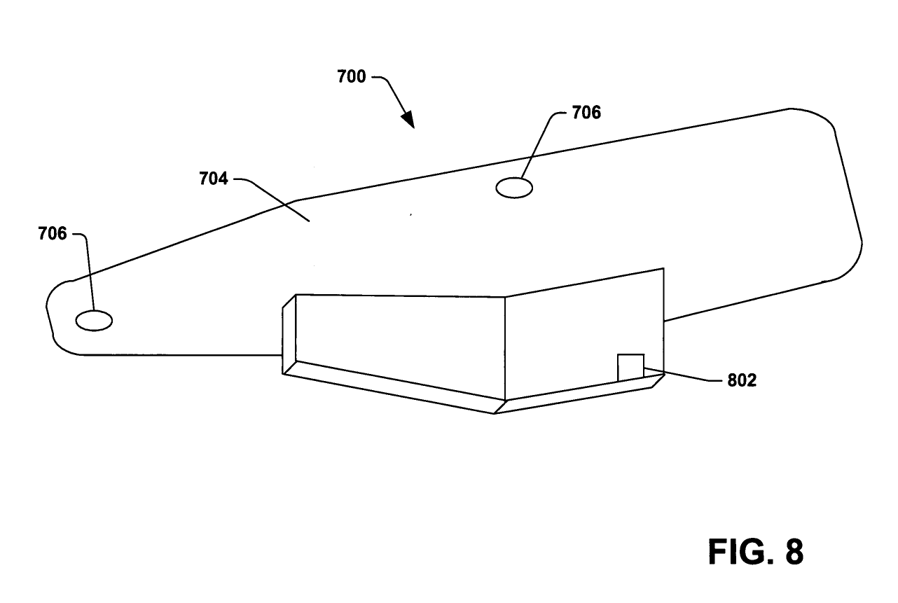

FIG. 8 illustrates the exemplary GPS antenna assembly 700 from a second viewing angle. As depicted, the exemplary GPS antenna assembly 700 further comprises a spring contact 802 associated with the radiator 702 (FIG. 7). The spring contact 802 can be employed as a single contact point to facilitate mounting the GPS antenna assembly 700 and an IFA antenna to a PWB.

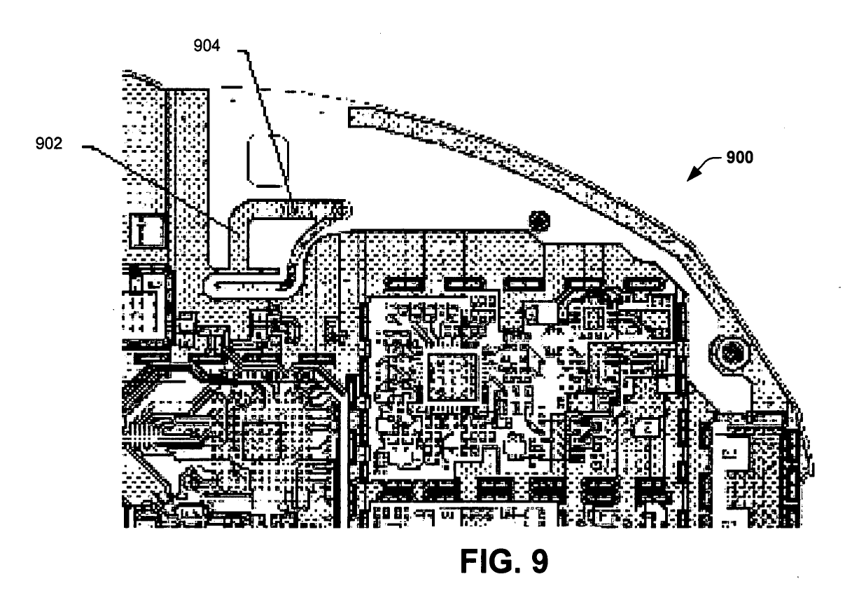

FIG. 9 illustrates a portion of a PWB 900 comprising a GPS antenna mounting mechanism that is utilized in connection with the GPS antenna assembly 700 (FIG. 7). The GPS antenna mounting mechanism comprises a GPS gamma match (“F”) 902 that comprises a spring contact point 904. The GPS gamma match 902 can be employed to impedance match the GPS antenna assembly 700 and to facilitate coupling the GPS antenna assembly 700 and an IFA antenna to the PWB 900. The GPS Gamma match 902 provides a single connection point, or the spring contact point 904. Alternatively, two or more connection points can be employed to facilitate tuning the antenna assembly 700 to enable such assembly to provide for GPS data reception and receive diversity. Furthermore, the GPS gamma match 902 on the PWB 900 can be easily modified, even after the design of the GPS assembly 700. Additionally, it is to be appreciated that the foregoing can be utilized with various other IFA antenna configurations, for example the configurations described below.

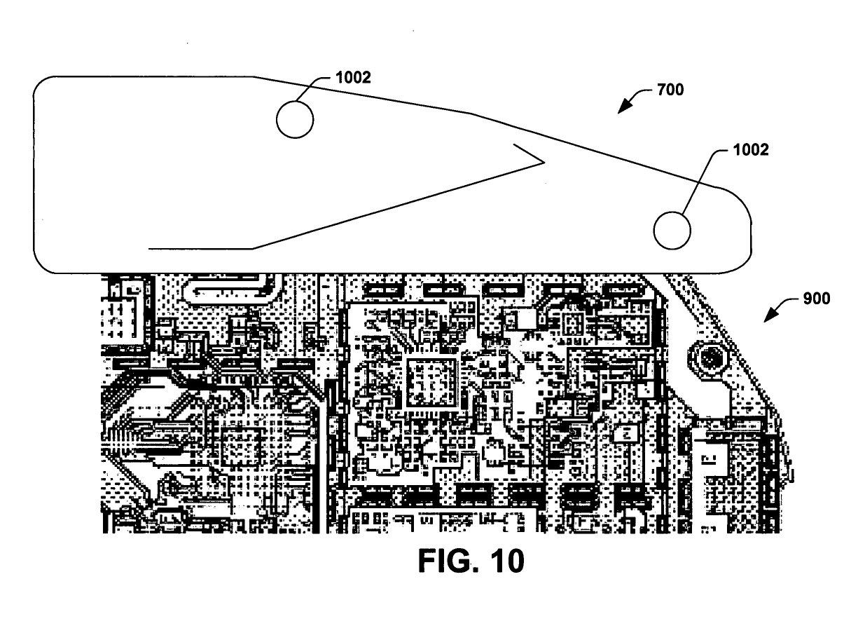

FIG. 10 illustrates a portion of the PWB 900 with the GPS antenna assembly 700 mounted thereon via a mounting mechanism 1002. The mounting mechanism 1002 can comprise various known mounting components such fastening and securing components. The mounting mechanism 902 can be employed to secure the GPS antenna assembly 700 to the PWB 900.

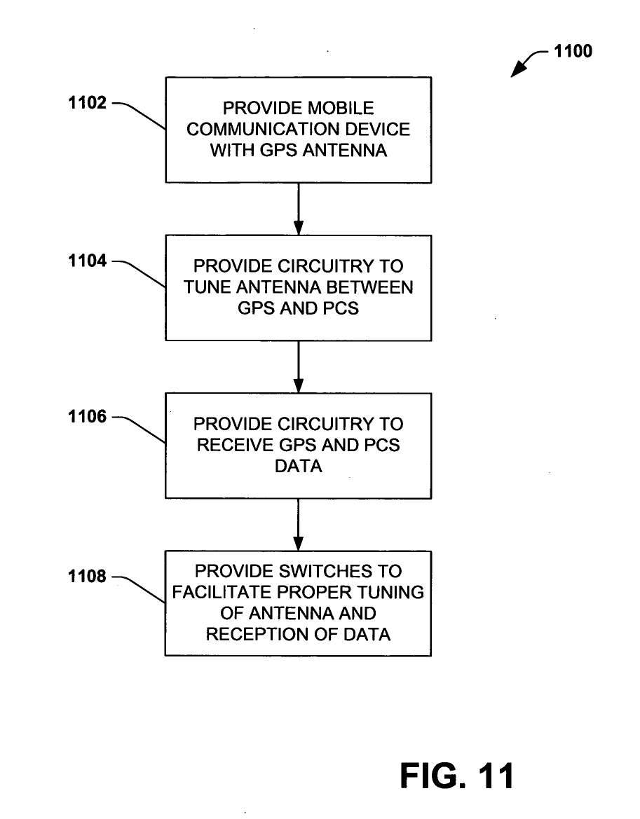

Now referring to FIG. 11, a methodology 1100 that facilitates adding receive diversity to a phone already comprising a GPS antenna is illustrated. Note that the GPS antenna cannot be part of a multi-band antenna already including the frequency band being used for receive diversity. At 1102, a mobile communication device including a GPS antenna is provided. In accordance with one aspect of the present invention, the GPS antenna can be a TOPIFA antenna that exhibits circular polarization characteristics. However, it is to be understood that the antenna can be any suitable antenna, such as a suitable microstrip antenna, L-plane antenna, PIFA antenna, monopole, helix, combination of monopole and helix, whip, etc. Moreover, the present invention contemplates utilization of any design of a mobile communication device comprising a GPS antenna for modification in connection with adding receive diversity in a PCS band.

At 1104, tuning circuitry is provided to facilitate dynamic tuning of the existing GPS antenna between a GPS band and a PCS band (e.g., between 1.575 GHz and 1.91 GHz or 1.7 GHz or 2.1 GHz etc.). The tuning circuitry can employ extensions of disparate lengths to effectuate dynamic tuning of the GPS antenna. Furthermore, the provided circuitry can alter an electrical length of a radiating antenna element associated with the GPS antenna to effectuate dynamic tuning of the GPS antenna. Moreover, other suitable circuitry can be utilized in connection with dynamically tuning the GPS antenna (e.g., two disparate circuits can be employed—a first to tune the antenna to a GPS band and a second to tune the antenna to a PCS band). For example, circuitry can be provided to facilitate tuning of a TOPIFA GPS antenna between a GPS reception band and a PCS reception band upon receipt of a signal with one or more frequencies related to such bands.

At 1106, GPS and PCS receivers are provided to enable reception, transduction, manipulation, and/or processing of a signal directed to the mobile communication device in a PCS or GPS band. At 1108, switches are provided to selectively couple the antenna to appropriate tuning circuitry and an appropriate receiver. For instance, if a GPS signal is directed to the mobile communication device, a first switch can couple the antenna to GPS tuning circuitry to provide for appropriate tuning of the antenna, and a second switch can couple the antenna to a GPS receiver for transduction, manipulation, and/or processing of the signal.

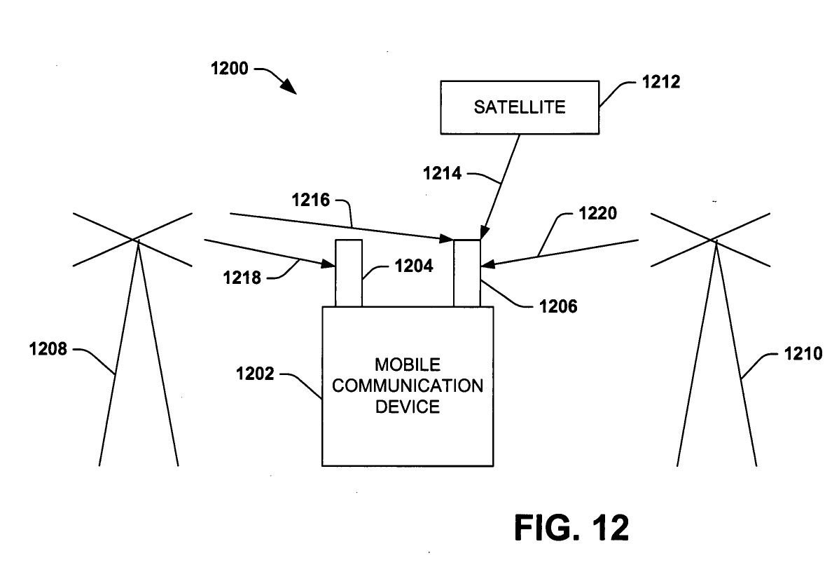

Now referring to FIG. 12, an exemplary environment 1200 that more particularly displays one or more benefits of the present invention is illustrated. The environment 1200 includes a mobile communication device 1202 that comprises an antenna 1204 dedicated to receiving PCS signals and an antenna 1206 that can be utilized for receive diversity within the PCS band and GPS signal reception. While shown external of the mobile communication device 1202, it is to be understood that the illustrated embodiment is only exemplary, and the antennas 1204 and 1206 can be internal and/or external antennas. The environment 1200 also includes base stations 1208 and 1210 that output signals in a PCS band that are to be received by the mobile communication device 1202. Furthermore, a satellite 1212 that outputs GPS signals for reception by the mobile communication device 1202 is also included within the exemplary environment 1200.

In accordance with one aspect of the present invention, the satellite 1212 can output a GPS signal 1214 to be received by the mobile communication device 1202 and the base station 1208 can output a PCS signal 1216 to be received by the mobile communication device 1202. Typically, the antenna 1206 automatically configure to enable reception of GPS signals from the satellite 1212 when GPS data reception is desired, as a user will typically not notice a difference in operation when receive diversity is not enabled. Thus, the antenna 1204 will receive the PCS signal 1216 from the base station 1208 and the antenna 1206 will receive the GPS signal 1214 from the satellite 1212. In accordance with another aspect of the present invention, when PCS data reception is desired, the antenna 1206 will automatically configure to enable reception of PCs signals. More particularly, the antenna 1204 can receive a PCS signal 1216 and the antenna 1206 can receive a PCS signal 1218, thereby improving a link to that base station 1208. It is to be understood that the signals 1216 and 1218 can comprise substantially similar data and/or disparate data. Providing the mobile communication device 1202 with receive diversity capabilities enables more users to be on a network at a substantially similar time, can improve a link between the base station 1208 and the mobile communication device 1202, and can further increase data rate throughput.

In accordance with another aspect of the present invention, when PCS data reception is desired, the antenna 1206 will automatically configure to enable reception of PCS signals. More particularly, the antenna 1204 can receive the PCS signal 1216 from the base station 1208 and the antenna 1206 can receive a PCS signal 1220 from the base station 1210. Thus, each antenna can be receiving signals from a disparate base station. An advantage of such an aspect is to mitigate fading that can occur in conventional mobile communication devices.

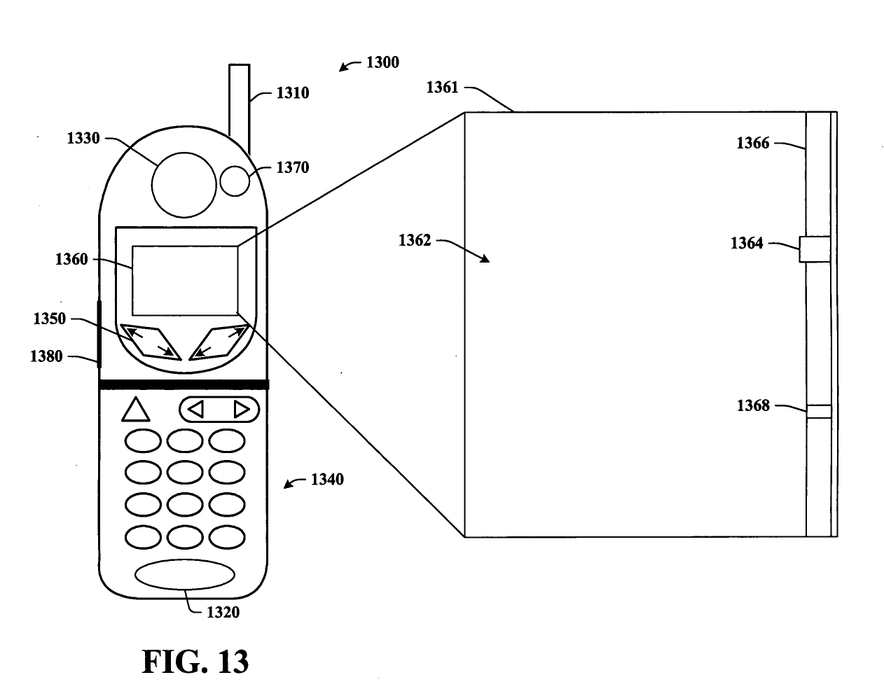

FIG. 13 illustrates an exemplary mobile (e.g., portable and wireless) telephone 1300 that can employ the novel aspects of the present invention. The mobile telephone 1300 comprises an antenna 1310 that communicates (e.g., transmit and receive) radio frequency signals with one or more base stations. The antenna 1310 can be coupled to duplexer circuitry (e.g., as described herein) within the mobile telephone 1300. In addition, the mobile telephone 1300 can include a separate signal-receiving component (not shown) that can also be coupled to the duplexer.

The mobile telephone 1300 further comprises a microphone 1320 that receives audio signals and conveys the signals to at least one on-board processor for audio signal processing, and an audio speaker 1330 for outputting audio signals to a user, including processed voice signals of a caller and recipient music, alarms, and notification tones or beeps. Additionally, the mobile telephone 1300 can include a power source such as a rechargeable battery (e.g., Alkaline, NiCAD, NiMH and Li-ion), which can provide power to substantially all onboard systems when the user is mobile.

The mobile telephone 1300 can further include a plurality of multi-function buttons including a keypad 1340, menu navigating buttons 1350 and on-screen touch sensitive locations (not shown) to allow a user to provide information for dialing numbers, selecting options, navigating the Internet, enabling/disabling power, and navigating a software menu system including features in accordance with telephone configurations.

A display 1360 can be provided for displaying information to the user such as a dialed telephone number, caller telephone number (e.g., caller ID), notification information, web pages, electronic mail, and files such as documents, spreadsheets and videos. The display 1360 can be a color or monochrome display (e.g., liquid crystal, CRT, LCD, LED and/or flat panel), and employed concurrently with audio information such as beeps, notifications and voice. Where the mobile telephone 1300 is suitable for Internet communications, web page and electronic mail (e-mail) information can also be presented separately or in combination with the audio signals.

In one aspect of the present invention, the display 1360 can be utilized in connection with a graphical user interface (GUI) 1361. The GUI 1361 can include a viewing window 1362 where data can be displayed to the user. The user can navigate through the data via a slider 1364 and a scroll bar 1366. In addition, the user can mark areas of interest, or focus areas via the novel aspects of the invention, as described herein, such that the user can navigate to other areas of data and be able to return to the area of interest. Thus, the user can view data that exceeds the bounds of the GUI 1361 via displaying portions the data within the GUI 1361 and marking areas of interest in order to quickly return to such areas as desired. For example, the GUI 1361 can include a focus indicia 1368 associated with an item identified as a point of focus. The user can define the item of focus while the item is visible within the GUI 1361. Then, the user can navigate to another area of the data. When the user desires to return to the focus point, the user can move the slider 1364 over the indicia 1368, which will return the focus item to the GUI 1361 or the user can invoke the indicia 1368 to automatically return the focus item to the GUI 1361.

The menu navigating buttons 1350 can further enable the user to interact with the display information. In support of such capabilities, the keypad 1340 can provide keys that facilitate alphanumeric input, and are multifunctional such that the user can respond by inputting alphanumeric and special characters via the keypad 1340 in accordance with e-mail or other forms of messaging communications. The keypad keys also allow the user to control at least other telephone features such as audio volume and display brightness.

An interface can be utilized for uploading and downloading information to memory, for example, the reacquisition time data to the telephone table memory, and other information of the telephone second memory (e.g., website information and content, caller history information, address book and telephone numbers, and music residing in the second memory). A power button 1370 allows the user to turn the mobile telephone 1300 power on or off.

The mobile telephone 1300 can further include memory for storing information. The memory can include non-volatile memory and volatile memory, and can be permanent and/or removable. The mobile telephone 1300 can further include a high-speed data interface 1380 such as USB (Universal Serial Bus) and IEEE 1394 for communicating data with a computer. Such interfaces can be used for uploading and downloading information, for example website information and content, caller history information, address book and telephone numbers, and music residing in the second memory. In addition, the mobile telephone 900 can communicate with various input/output (I/O) devices such as a keyboard, a keypad, and a mouse.

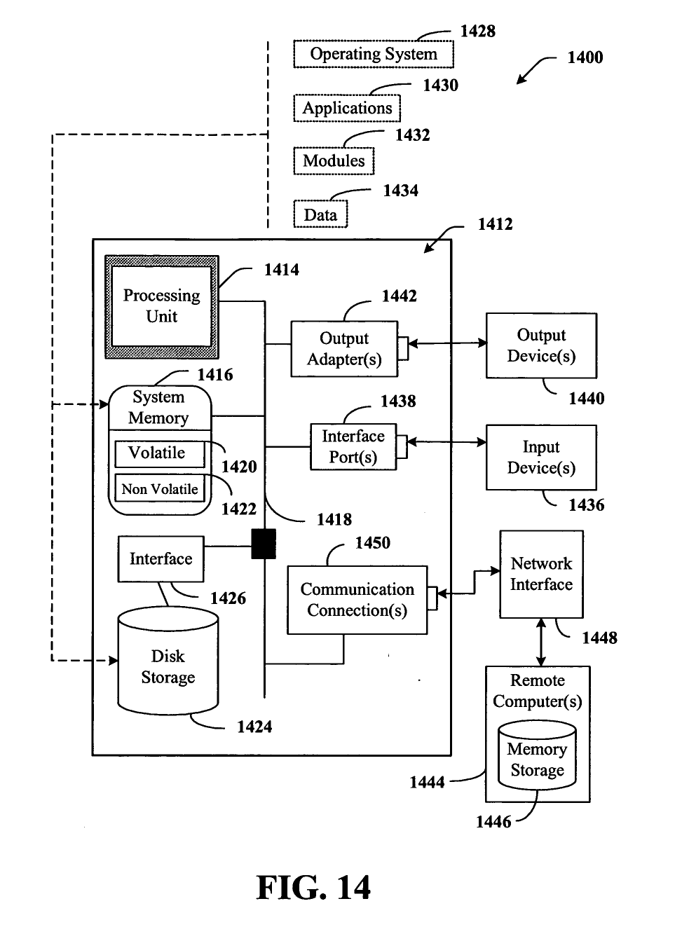

In order to provide a context for the various aspects of the invention, FIG. 14 as well as the following discussion are intended to provide a brief, general description of a suitable computing environment in which the various aspects of the present invention can be implemented. While the invention has been described above in the general context of computer-executable instructions of a computer program that runs on a computer and/or computers, those skilled in the art will recognize that the invention also can be implemented in combination with other program modules. Generally, program modules include routines, programs, components, data structures, etc. that perform particular tasks and/or implement particular abstract data types.

Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

With reference to FIG. 14, an exemplary environment 1410 for implementing various aspects of the invention includes a computer 1412. The computer 1412 includes a processing unit 1414, a system memory 1416, and a system bus 1418. The system bus 1418 couples system components including, but not limited to, the system memory 1416 to the processing unit 1414. The processing unit 1414 can be any of various available processors. Dual microprocessors and other multiprocessor architectures also can be employed as the processing unit 1414.

The system bus 1418 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable ROM (EEPROM), or flash memory. Volatile memory 1420 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1412 also includes removable/non-removable, volatile/non-volatile computer storage media. FIG. 14 illustrates, for example a disk storage 1424. Disk storage 1424 includes, but is not limited to, devices like a magnetic disk drive, floppy disk drive, tape drive, Jaz drive, Zip drive, LS-100 drive, flash memory card, or memory stick. In addition, disk storage 1424 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1424 to the system bus 1418, a removable or non-removable interface is typically used such as interface 1426.

It is to be appreciated that FIG. 14 describes software that acts as an intermediary between users and the basic computer resources described in suitable operating environment 1410. Such software includes an operating system 1428. Operating system 1428, which can be stored on disk storage 1424, acts to control and allocate resources of the computer system 1412. System applications 1430 take advantage of the management of resources by operating system 1428 through program modules 1432 and program data 1434 stored either in system memory 1416 or on disk storage 1424. It is to be appreciated that the present invention can be implemented with various operating systems or combinations of operating systems.

A user enters commands or information into the computer 1412 through input device(s) 1436. Input devices 1436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1414 through the system bus 1418 via interface port(s) 1438. Interface port(s) 1438 include, for example, a serial port, a parallel port, a game port, and a universal serial bus (USB). Output device(s) 1440 use some of the same type of ports as input device(s) 1436. Thus, for example, a USB port may be used to provide input to computer 1412, and to output information from computer 1412 to an output device 1440. Output adapter 1442 is provided to illustrate that there are some output devices 1440 like monitors, speakers, and printers, among other output devices 1440, which require special adapters. The output adapters 1442 include, by way of illustration and not limitation, video and sound cards that provide a means of connection between the output device 1440 and the system bus 1418. It should be noted that other devices and/or systems of devices provide both input and output capabilities such as remote computer(s) 1444.

Computer 1412 can operate in a networked environment using logical connections to one or more remote computers, such as remote computer(s) 1444. The remote computer(s) 1444 can be a personal computer, a server, a router, a network PC, a workstation, a microprocessor based appliance, a peer device or other common network node and the like, and typically includes many or all of the elements described relative to computer 1412. For purposes of brevity, only a memory storage device 1446 is illustrated with remote computer(s) 1444. Remote computer(s) 1444 is logically connected to computer 1412 through a network interface 1448 and then physically connected via communication connection 1450. Network interface 1448 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1450 refers to the hardware/software employed to connect the network interface 1448 to the bus 1418. While communication connection 1450 is shown for illustrative clarity inside computer 1412, it can also be external to computer 1412. The hardware/software necessary for connection to the network interface 1448 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that effectuates receive diversity within a mobile communication device, comprising:
a first antenna that facilitates reception of signals in at least one of a PCS band, a cellular band, a Korean PCS band, and a China PCS band; and
a second antenna that facilitates reception of signals in a GPS band and at least one of the bands received by the first antenna, wherein tuning of the second antenna depends upon a signal type relayed to the second antenna.

2. The system of claim 1, the second antenna is selectively tuned to receive signals in at least one of the bands received by the first antenna when reception of signals in a GPS band is not desirable.

3. The system of claim 1, the second antenna is a top-mounted inverted F-antenna.

4. The system of claim 3, the top-mounted inverted F-antenna exhibits circular polarization characteristics.

5. The system of claim 1, further comprising:
a first tuning component that facilitates tuning the second antenna for reception of signals in a GPS band; and
a second tuning component that facilitates tuning the second antenna for reception of signals in at least one of the bands received by the first antenna.

6. The system of claim 5, further comprising a RF switch that facilitates coupling the second antenna to one of the first tuning component and the second tuning component.

7. The system of claim 5, the RF switch being one of a PIN-diode, a MEMS switch, and a FET switch.

8. The system of claim 1, further comprising:
a first receiving component that facilitates at least one of transduction, modulation, and processing of a signal in at least one of the bands received by the first antenna; and
a second receiving component that facilitates at least one of transduction, modulation, and processing of a GPS signal.

9. The system of claim 8, further comprising a RF switch that facilitates coupling the second antenna to one of the first receiving component and the second receiving component.

10. The system of claim 9, the RF switch being one of a PIN-diode, a MEMS switch, and a FET switch.

11. The system of claim 1, further comprising a component that determines frequency of a signal desirably received by the second antenna.

12. The system of claim 1, further comprising an emergency component that automatically configures the second antenna to receive a GPS signal upon transmitting data to an emergency number.

13. A mobile telephone comprising the system of claim 1.

14. The system of claim 1, the second antenna comprising a radiating antenna element that is coupled to a transmission line, wherein length of the transmission line is selectable between at least two lengths.

15. The system of claim 1, the second antenna being at least one of a PIFA antenna, whip antenna, microstrip antenna, L-plane antenna, monopole antenna, E-plane antenna, dielectric resonator antenna, and helix antenna.

16. The system of claim 1, further comprising:
a first switch that couples one of a first tuning component and a second tuning component to the second antenna, wherein the first tuning component facilitates reception of a GPS signal on the second antenna and the second tuning component facilitates reception of a signal in at least one of the bands received by the first antenna on the second antenna;
a second switch that couples one of a first receiving component and a second receiving component to the second antenna, wherein the first receiving component facilitates one of transduction, modulation, and processing of a GPS signal and the second receiving component facilitates one of transduction, modulation, and processing of a signal in at least one of the bands received by the first antenna; and
a control component that relays commands to at least one of the first switch and second switch to facilitate a desirable coupling, the coupling based at least in part upon a type of signal desirably received by the second antenna.

17. A method for effectuating receive diversity within a mobile communication device, comprising:
providing a first antenna that facilitates reception of a signal in at least one of a PCS band, a cellular band, a Korean PCS band, and a China PCS band;
providing a second antenna that facilitates reception of a signal in a GPS band;
determining whether a signal in a GPS band is desirably received by the second antenna; and
tuning the second antenna to facilitate reception of a signal in at least one of the bands received by the first antenna if reception of a signal in a GPS band is not desirable.

18. The method of claim 17, further comprising altering a length of a transmission line associated with the second antenna to tune the second antenna.

19. The method of claim 17, further comprising altering an electrical length of a resonating element associated with the second antenna to tune the second antenna.

20. The system of claim 17, further comprising tuning the second antenna to receive a signal in a GPS band if a signal in a GPS band is desirably received by the second antenna.

21. A method for modifying a mobile communication device to enable receive diversity, comprising:
providing a mobile communication device that includes a first antenna tuned to receive a signal in at least one of a PCS band, a cellular band, a Korean PCS band, and a China PCS band, and a second antenna tuned to receive a signal in a GPS band;
coupling the second antenna to a first switch;
further coupling the first switch to one of a first tuning circuit that facilitates tuning the second antenna for reception of a signal in a GPS band and a second tuning circuit that facilitates tuning the second antenna for reception of a signal in at least one of the bands received by the first antenna;
coupling the second antenna to a second switch; and
further coupling the second switch to one of a first receiving component that facilitates one of processing, transduction, and modulation of a signal in a GPS band and a second receiving component that facilitates one of processing, transduction, and modulation of a signal in at least one of the bands received by the first antenna.

22. A system that enables receive diversity to be existent within a mobile communication device, comprising:
means for configuring a first antenna to receive data in at least one of a PCS band, a cellular band, a Korean PCS band, and a China PCS band;
means for configuring a second antenna to receive one of data in at least one of the bands received by the first antenna and GPS data at a particular instance, the configuring of the second antenna based at least in part upon a type of signal desirably received by the second antenna.

23. The system of claim 22, the second antenna being a top-mounted inverted F antenna.

24. A system that facilitates receive diversity within a mobile communication device, comprising:
a first antenna that facilitates reception of signals in at least two frequency bands;
a second antenna that facilitates reception of signals in a GPS band and at least one of the frequency bands received by the first antenna; and
a tuning component that dynamically tunes the second antenna to the frequency currently received by the first antenna for at least one frequency band when reception of a GPS signal is not desirable.
